(19) United States
(12) Patent Application Publication
(10) Pub. No.: US 2023/0261869 A1
(43) Pub. Date: Aug. 17, 2023

(54) PROCESS FOR CREATING A TRADABLE NONFUNGIBLE TOKEN FOR RECYCLABLE MATERIALS

(71) Applicant: Matter Management Enterprises, LLC, West Point, GA (US)

(72) Inventor: Charles Milton Russell, III, Forsyth, GA (US)

(73) Assignee: Matter Management Enterprises, LLC, West Point, GA (US)

(21) Appl. No.: 17/672,197

(22) Filed: Feb. 15, 2022

(51) Int. Cl. H04L 9/32; G06F 16/68; G06F 21/16; G06F 21/62

(52) U.S. Cl. CPC H04L 9/3213; G06F 16/68; G06F 21/16; G06F 21/6218; H04L 2209/38; H04L 2209/56; H04L 2209/60

(57) ABSTRACT

A process is disclosed for establishing ownership and value in collected recyclables. Collected solid waste is transported to a collection facility and weighed at entry and an amount of deposited recyclables determined and attributed to each customer serviced in the collection jurisdiction. A digital file is created representing the attributed amount of recyclables for each customer, and a worker utilizes a third-party tokenization service to convert the digital file into a nonfungible token or NFT, thereby establishing value for the NFT. The tokenization provider then mints and records the nonfungible token on a targeted blockchain using smart contracts, such as for example on the Ethereum blockchain, and sends a confirmation to the waste collection contractor. The waste collection contractor then transfers the NFT to the customer so that the customer may freely trade the NFT on the open market. The process promotes a sustainable recycling program for the public.

### FIELD OF THE INVENTION

The present invention relates generally to the use of nonfungible tokens (“NFT” or “NFTs”) for establishing ownership over waste materials. In greater particularity, the present invention relates to the use of NFTs to motivate consumers to recycle materials. In another manner, the current invention relates to creating a secondary marketplace for recyclable materials.

### BACKGROUND OF THE INVENTION

Municipal Solid Waste (“MSW”), commonly referred to as garbage or trash, is nonhazardous disposable materials generated by households, institutions, industries, agriculture, and sewage. It is made up of waste, organics, and recyclable materials, with a municipality typically overseeing its disposal. Necessarily, MSW must be collected, separated, and sent to either a landfill or recycling center for processing. As a part the removal efforts of MSW, most waste is simply discarded in a landfill because it is no longer economically useful. However, MSW should only be considered permanently disposable waste if the material in the MSW cannot be recycled.

Interestingly, even though waste generally originates from a number of sources it really has no direct connection to any particular municipal activity. Nevertheless, due to the traditional role of municipalities and their organizational purpose to protect their communities the collecting and managing of waste has, over time, become associated with the word “municipal.” Hence, the collective public has come to associate solid waste management with a local governmental or municipal responsibility, thereby scattering that responsibility among thousands of local governments.

A large and growing portion of MSW is plastic. Plastic invented in the mid-1900′s is essentially a chain of synthetic polymers made from fossil fuel-based chemicals and has the highly desirable characteristic of durability, once manufactured into its final form, and low cost when manufactured in high volumes. Four to 8 percent of global oil consumption is used in the production of plastics today. In the 1970′s the popularity of plastics skyrocketed, and manufacturers began replacing traditionally paper or glass items with lighter or more durable and affordable plastic alternatives. For example, plastic jugs replaced milk jars, plastic straws replaced paper straws, and Styrofoam™ type plastic replaced food containers. Since the 1950′s, over 8 billion metric tons of plastics have been produced, and more than half of that was produced in the past 15 years. Understandably, the public has a growing concern that plastics are a major, if not primary, contributor to MSW and to pollution in general.

Of particular concern in MSW is “single use plastics.” Single-use plastics are goods that are made primarily from plastics which are meant to be disposed of immediately after use, often within in a few minutes of use. Single use plastics are most commonly used for material packaging and food service ware, but single use plastics unless specifically designed for self-degradation do not break down, but only break-up into smaller and smaller particles. Over time, the effects of sun and heat gradually turn plastics into smaller and smaller pieces until they eventually become what are known as “microplastics.” These microscopic plastic fragments, usually smaller than 5 millimeters in diameter, are hard to detect due to their inert composition design. Further, microplastics are sometimes even small by design. For example, microbeads of plastic having diameters of less than 500 nm (nanometers) are used in facial scrubs or in the microfibers of polyester clothing. When these items break apart over time after being discarded, the microbeads end up in the water, eaten by wildlife, and eventually inside our bodies. For wildlife, microplastics can be particularly dangerous. When consumed, these microplastics can easily accumulate inside an animal’s body and cause health issues, like punctured organs or fatal intestinal blockages.

The incredible versatility of plastic materials accounts for the continued growth in plastic production year after year. In tandem with that growth, the market value of plastics also continues to grow. Plastics are adding to the total amount of MSW produced by each human, with the U.S. Per capita MSW generation increased from 4.5 pounds per person per day in 2017 to 4.9 pounds per person per day in 2018, with plastics accounting for 12.2% of the total MSW generated in 2018.

In addition to microplastics themselves, the chemicals used in plastics can contaminate water which is then absorbed by fish and other aquatic life. This contamination does not stop with water organisms, but spreads throughout the food chain, affecting human health through water-based foods. Also, people are affected by water pollution directly, especially in communities that rely on well water as a supply source. Unfortunately, the explosion of single use plastics for containers and other items has overwhelmed the ability of municipalities to collect and process plastic properly, resulting in the proliferation incorporation of plastic-based chemicals in the food chain.

Most consumers are unaware that they are consuming microplastics. However, the medical community is starting to become concerned about the effects of plastic particles on the human body, and an emerging belief is that having plastic particles in the food chain is harmful to human health. Many chemicals that are added to plastics during processing and many of those chemicals are known endocrine disruptors. Research is beginning to suggest that human exposure to these plastic chemicals will cause negative health effects, including hormonal imbalances, reproductive problems like infertility, and even cancer. For example the chemical phthalate DEHP often added to plastic goods like shower curtains and garden hoses to make them more flexible has been found to be a probable human carcinogen by the U.S. Environmental Protection Agency. Given the rising health risks, and the general volume explosion of plastic in MSW, the proper management of MSW and its intelligent removal from society are essential to curb the growing MSW problem and allow us to live in a sustainable, carbon reduced society.

Generally, MSW is managed and consolidated by local governments hiring private contactors. Typically, curbside collection by contractors or personal delivery of MSW accounts for most consolidation of MSW into Landfills. The public by and large believes that a substantial portion of MSW is recycled. Unfortunately, this is not true. According to a recent report from the New York Times, hundreds of local recycling programs in American cities and towns are collapsing. Many states, such as Tennessee, Florida, and Pennsylvania, are reportedly sending newspapers, cans, and bottles to landfills, while other states are now burning their waste. China where a lot of recyclable materials where for decades were once shipped recently outlawed the receipt of any further recyclables. This has exacerbated the domestic buildup of recyclables in many countries, including the U.S. As a treasurer in California recently announced, “We are in a crisis moment in the recycling movement right now.” Because U.S. recycling was dependent on China for so many years, our domestic recycling infrastructure was never developed, and now there no economical or efficient way to handle actual recycling of recyclables.

Moreover, the politics of MSW disposal currently do not support recycling. Recycling is basically just another municipal service which competes with local funding of infrastructure projects, such as road maintenance, school building, and public safety systems. Due to the manner in which most democratic political systems operate, most voters do not support the funding of recycling over other basic funding programs, and without dedicated investment, recycling infrastructure has never developed. Hence, most municipalities simply pick the cheapest route to address the disposal MSW which is putting it into a landfill, rather than do any actual processing of recyclables.

Making the situation more complicated, the U.S. does not have a federal recycling program. The allocation of funds towards recycling systems is currently made by approximately 20,000 different communities across the U.S. Each community has various stakeholders, each having varying and competing interests, which interferes with a common ground or common goals from which each community may cooperate with one another. This makes it more difficult to bring together communities, recyclers, haulers, manufacturers and consumers to try to create a sustainable recycling community.

Interestingly, the global market for high quality recycled materials is actually growing. MSW is generally composed of the following divisions: paper and paper-based products (23%); plastics (12%), food and food derivatives (22%), metals and glass (13%), yard plant waste (12%), and wood, rubber, leather, and miscellaneous inorganic wastes account for the rest (about 18%). Of these classes, paper, plastics, and glass and metals, account for 70% of all MSW. If you include other potentially recyclable materials (e.g. wood) in all collected MSW approximately 85% is recyclable. Hence, the majority of collected MSW is potentially recyclable.

Global demand for paper and cardboard is expected to grow by 1.2 percent a year, mainly due to the growth in e-commerce and the need for packaging, and utilizing recycled paper will be essential to meeting this demand. Moreover, the global plastic recycling market is projected to grow by $14.74 billion between now and 2024. As a result, companies are trying to enhance the quality of recycled plastic as well as incorporate recycled plastics into the plastic products they produce. Plastic waste, such as PET and HDPE plastics are being increasingly recycled into packaging, building and constructions, electronics, automotive, furniture, textiles and more. Therefore, both the demand for and technical capability to produce recycled materials is robust and growing.

For the U.S., and most other countries, the key to fixing recycling is developing a production economy for recyclables. This means improving the technology for sorting and recovering materials, incorporating more recycled material into products, getting these products into the marketplace and creating a sustainable demand for recyclables. For example, some institutions and cities require a percentage of recycled content be a part of all products purchased. For example, they may require 100 percent recycled paper be used, and recycled materials be used in all new building projects. An increase in demand for recyclables can also be driven by changes in regulations and purchasing commitments. For example, institutions or municipal governments can require that the disposal of construction and demolition debris be done in a manner that encourages recycling of those materials instead of deposition into a landfill. If recycling processors have a market where they can sell their material, they will be motivated to invest in better equipment that can sort materials to minimize contamination, which will expand recycling programs. Hence, institutions and government has a vital role to help foster a stable system that allows for the growth of markets for reused and recycled materials, as well allow for capital to produce facilities that can process recyclable materials.

While some recyclable materials are voluntarily deposited in public receptacles, the bulk of recyclable materials are collected at a waste designated collection location specified by collection contractor or through municipal rules in a community. Hence, what normally occurs is consumer typically does a pre-sort of recyclables by separating each type of recyclable into separately designated bins provided by the collection company, which are then collected in a convenient location on a weekly or bi-weekly basis. Alternatively, municipalities may opt for no required pre-sorting by a waste customer and simply collect all waste in a single trash bin or receptacle. This non-presorting strategy is often preferred because customers may not like to do such hand, pre-sorting, and because such pre-sorting can become a complicated process given all of the forms of consumer products today. This can cause unreliable sorting because a consumer is typically untrained or indifferent as to the accuracy of their hand, pre-sorting quality. Further, creating a dual system of collection, often with separate collection times and separate collection vehicles, increases cost and complexity for a waste collection strategy. Instead, municipalities may choose to keep recyclables commingled in a single collection container for each customer until the waste is collected and transported to a materials recovery facility where waste can be accurately separated by machines and/or trained workers. However, a successful sorting and separation of recyclable materials is critical to the re-integration of the recyclables into a new manufacturing process for consumer products.

While seemingly unrelated, cryptocurrency and nonfungible tokens in particular may have a role to play in promoting the economics of recycling. Recently, nonfungible tokens or “NFTs” as they are commonly referred to have emerged onto the marketplace and are being used to increase the value of various types of items. NFTs are a special form of cryptocurrency asset in which a unique token is assigned to a real-world asset. Conversely, a “fungible” assets like Bitcoin or a fiat currency are all worth exactly the same amount at any particular moment in the marketplace. Nonfungible tokens are unique because they allow for the simultaneous proof of both the ownership and “provenance” (i.e. the ability to track ownership changes over time and trace authenticity) of an item. For comparison, a traditional deed to title for a car or real property secures ownership in that asset, and such titles are usually recorded and are searchable in municipal or county records to verify ownership. The title shows ownership in the care or real property, but the title is not the asset itself. Similarly, an NFT relies on information about an asset, usually referred to as “metadata” used to confirm ownership in an entity and record the history of that ownership. Metadate also includes information like, a description of the asset, the original creator of the asset, an image of the asset, the date of creation of the asset, and royalty rights in the asset, including down-stream, recurring royalty rights at each sale of the asset down the line of resales that occurs.

The value of an NFT exists because it can be recorded on a blockchain, but the assets they represent may or may not exist on the blockchain. This means that NFTs can represent digital as well as physical assets. For example, both digital art and physical baseball cards both can be assets that can be assets controlled by an NFT. More importantly, these assets can through NFTs be available for repeated sale on the free market via blockchain recordation platforms, like the Ethereum network.

Nonfungible tokens are always incorporated into smart contracts because this is how these tokens are added to targeted blockchains. The most popular smart contract blockchain is the Ethereum platform. Ethereum has emerged as one of the most popular platform on which to issue and mint NFT’s. At its core Ethereum developers have integrated several minting standards, including ERC721, ERC1155, ERC994, ERC809, ERC1201, and ERC998. These various standards allow for the creation of diverse types of tokens and recordation of those tokens on the Ethereum blockchain and using a diverse set of cryptocurrency payment options.

Because every NFT is unique, they can be used to authenticate the ownership of digital assets like artworks, recordings, and virtual real estate or even pets, which has increased investment into the NFT market. An NFT always includes a unique and non-interchangeable set of metadata stored on a digital ledger or a “blockchain” as such recordation storage is commonly referred to. NFT’s use blockchain technology to provide a public proof of ownership in a particular item, with such ownership being able to be copied, shared, or sold, like any digital file.

NFTs function like cryptographic tokens, but, unlike cryptocurrencies like Bitcoin, NFTs are not mutually interchangeable, hence not fungible. While all Bitcoins are equal in value, each NFT may represent a different underlying asset and thus may have a different value. The unique identity and ownership of an NFT is verifiable via the blockchain ledger, and this verifiable ownership allows for the license to use the underlying digital asset, but generally does not confer copyright ownership to a buyer. More importantly, successive sales (i.e. license) of an NFT permits via the metadata included in each NFT for a recurring transaction fee be automatically sent back to an original owner or creator of the NFT. This feature in NFT’s is proving to be a financial boon to artists.

Therefore, what is needed is a process or system for improving the overall economic system of recycling. Simultaneously, NFT’s are emerging as an asset value elevator, including both digital and physical assets. Applying the value enhancing potential of NFTs with recyclables may be one way to raise the overall economics of the recycling industry.

### SUMMARY OF THE INVENTION

It is the object of the present invention to provide a process for establishing ownership and value in collected recyclables. An amount of collected recyclables in a solid waste collection jurisdiction is transported to a collection facility and sorted into different types of recyclables. At the same time, the weight of the collected recyclables is determined and a weight ticket is issued. A worker at the collection contractor reviews the information on the ticket and attributes to each customer serviced in the collection jurisdiction their share in the collected recyclables in the solid waste for that particular collection truck. Once assigned to each serviced customer, a digital file recording numerical information representing the attributed amount of recyclables is created, and a currency value established for the recyclables. A worker at the waste collection contractor uses a third-party tokenization provider, via their website, to mint a nonfungible token and record it on a targeted blockchain using smart contracts, such as for example on the Ethereum blockchain, and receives a confirmation from the tokenization provider. The waste collection contractor can also, optionally, send the nonfungible token to a digital wallet owned by the customer so that the customer may freely trade the nonfungible token on the open market.

Other features and objects and advantages of the present invention will become apparent from a reading of the following description as well as a study of the appended drawings.

### BRIEF DESCRIPTION OF THE DRAWINGS

A process for creating a tradable, nonfungible token for recyclable materials incorporating the features of the invention is depicted in the attached drawings which form a portion of the disclosure and wherein:

FIG. 1 is an iconographic depiction of a current, standard recycling program for processing municipal solid waste;

FIG. 2 is an exploded step, break-down of a process for creating a tradable nonfungible token in a quantified amount of recyclable material;

FIG. 3 is processing flow diagram for minting a nonfungible token representing collected recyclable material collected from a municipal solid waste customer;

FIG. 4 is processing flow diagram for making a nonfungible token representing collected recyclable material available for trading by a customer; and,

FIG. 5 is processing flow diagram showing an alternative method for making a nonfungible token representing collected recyclable material available for trading by a customer.

### DESCRIPTION OF THE PREFERRED EMBODIMENTS

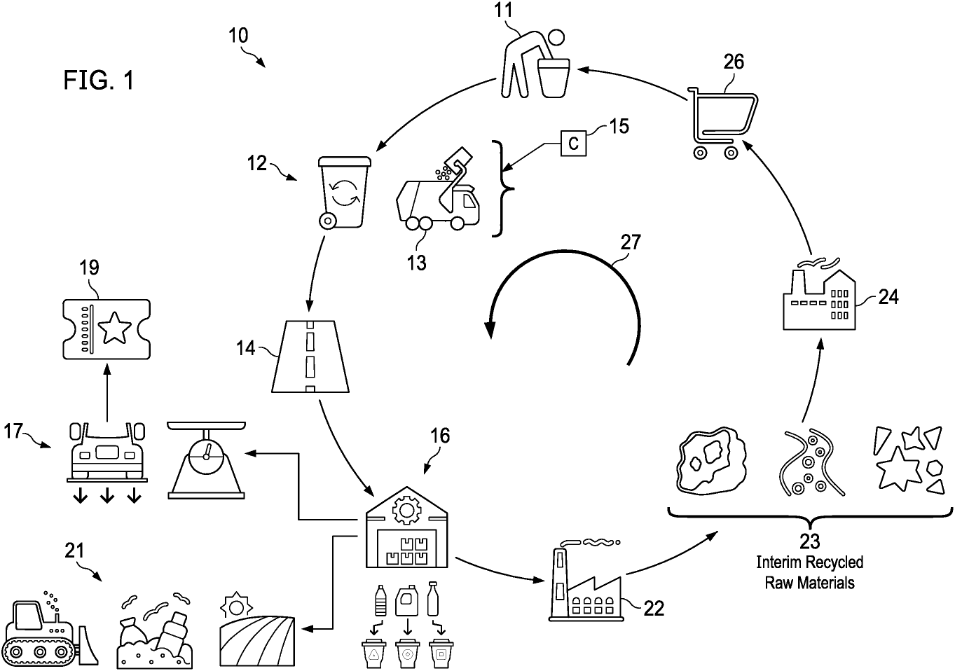

Referring to the drawings for a better understanding of the function and structure of the invention, FIG. 1 shows the current standard for recycling in the U.S. and North America. System 10 starts with solid waste customers 11, such as ordinary citizens, towns, municipalities, cities, and townships. For the purposes of this disclosure, the term “solid waste” means any garbage, trash, refuse, sludge from a waste treatment plant, water supply treatment plant, or air pollution control facility and other discarded materials, including solid, liquid, semisolid, or contained gaseous material resulting from industrial, residential, commercial, mining, and agricultural operations, and from community activities. However, solid waste does not include toxic, nuclear, biologically, or hazardous waste materials. A solid waste collection contractor 15, having a fleet of collection trucks 13, collects waste from recycling receptacles placed in designated areas on streets, alley ways, dumpsters, and other designated collection containers 12. Each collection vehicle 15 typically starts a collection route each day and collects solid waste in a predetermined geographical jurisdiction area. Once a collection truck is full, or if the specified jurisdiction has been fully serviced, a collection truck transports the collected solid waste to a collection and sorting facility 16. Collection facility 16 may be geographically distant from the truck’s collection jurisdiction requiring a long-distance route or a circuitous route of travel 14. This is because collection facilities tend to be large, centralized facilities to minimize fixed costs in the collection process, and further because collection facilities tend to be located away from residential and metropolitan areas to reduce the exposure of collection odors and contamination to populated areas.

Upon arrival at the collection facility 16, collection trucks are weighed 17. Collected waste is dumped in designated areas, and the truck is weighed again 17 just prior to exiting. A paper ticket 19 is generated that specifies the exact amount of solid waste deposited, and the ticket is stamped with an official seal to prevent tampering with ticket 19. Alternatively, in some collection areas of North America an electronic ticket is electronically transmitted to a designated database controlled by the solid waste collection contractor that operates the truck with a copy sent to the driver of the truck so that the driver can verify the amount of deposited solid waste. The ticket or the electronic equivalent is used to determine the charge to the municipality or collection waste contractor for processing the deposited waste. Charges are typically based on cost per pound of waste, and the costs are renegotiated yearly or quarterly.

Collection facility 16 is equipped as is known in the industry to sort municipal solid waste and separate the waste into recyclables and waste for landfills. Recyclables typically include paper products, wood, rubber, glass, metals, and plastics. Landfill materials usually consist of compostable materials such as readily biodegradable materials, like food, garden and plant materials, yard waste, and biodegradable oils and liquids. After separation, landfill materials are transported in various ways to designated landfill areas 21 where large land moving machines can distribute the landfill materials over large areas. Sorted and separated recyclables are transported via various methods to recycling factories 22 where each class of recyclables are processed into raw materials 23 that will be used as raw material in consumer product factories creating new products. For example, metals may be further sorted and melted into metal ingots of aluminum, steel, or copper; plastics may be crushed, heated, and shaped into plastic pellets usable as raw material for plastic injection molding machines; and, glass may be melted and formed into raw ingots for melting and reforming in other glass product production processes.

These interim raw materials 23 are sold to the various factories 24 that create retail products for sale in retail markets 26 for profit, assisting in the economic sustainability of the recycling ecosystem 27. The desired effect is that the process repeats 27 continually so that the environmental impact of municipal solid waste is minimized over time.

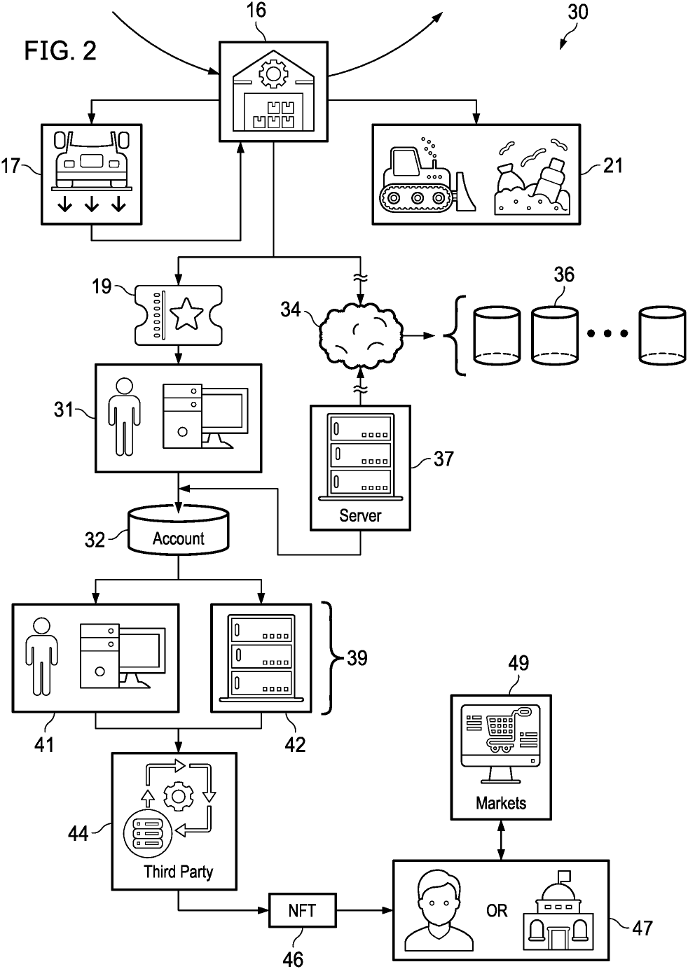

Referring to FIG. 2, it may be seen a modification to recycling process 10 to promote the elevation of the economies of the entire cycle 27 by increasing the value of recyclables 30. Ticketing of municipal solid waste occurs normally as in process 10 (see FIG. 1) with weighing 17 and ticket issuance 19 at sorting facility 16. However, ticket 19 is electronically transmitted to waste collection contractor for the processing by an employee at waste the collection contractor on computer termina 31. Nominally, a simple graphical representation of a ticket (e.g. a pdf file) holding a human discernable image of the ticket is transmitted to a storage location and viewed by a human worker 31. The worker reviews the image and enters a digital value of the ticket weight into a database 32 holding various accounts being serviced by the waste contractor and assigns to each respective customer in a particular jurisdiction the weight of the recyclables attributable to the customer. Alternatively, a digital version of ticket 19 is transmitted via internet connection 34 and recorded in cloud-based storage 36, and a computer server 37 which includes software retrieves recorded ticket values held in storage 36 and calculates and assigns the amount of recyclables attributable to each customer in a collection jurisdiction for the collection event represented by the weight recorded on ticket 19.

Based upon regional and state historical percentages, as determined by the EPA, each customer is assigned an attributed amount of recyclables for each collection action in each collection jurisdiction based upon a percentage of the weight recorded on ticket 19. Alternatively, a particular municipality may use a third-party consultant to assign an attributed amount of recyclables for each collection customer. The attributed percentage may also be modified from time to time based upon a particular municipality’s collection goals. The respective recyclable amounts for each customer are automatically recorded in database 32 and associated with each respective customer account as in manual process 31.

In either case, whether manual or electronic, an attributable amount of collected recyclable material is recorded and assigned to each customer for each ticket 19 issued by the collection facility 16.

Periodically, waste contractor accesses through a computer terminal a third-party tokenization service provider 44 that has the capability to “tokenize” an asset to produce a nonfungible token representative of a predetermined value for an asset. For the purposes of this disclosure, “Tokenization is defined as the process of converting rights to an asset into a digital token on a blockchain.” Further, an asset is herein defined as a resource with economic value that an individual, corporation, municipality, state, or country owns or controls with the expectation that it will provide future benefit.” A worker, typically a worker employed by the collection contractor, accesses 41 a tokenization service provider 44 and enters the requisite information in the service provider’s system to generate a nonfungible token or NFT representative of the attributable amount of recyclable material for each customer collected in the collection jurisdiction associated with ticket amount 19. Alternatively, an application running on a computer server 42 automatically accesses recorded attributable amounts of recyclable material for each user and using an API (Application Programming Interface) automatically requests generate of an NFT.

For the purposes of this disclosure, the name “nonfungible token” and “NFT” shall be used interchangeably. An NFT is the converted token of a digital asset created on a blockchain that proves the ownership and provenance of a real-world item. For example, on a blockchain, the authenticity of an NFT can be easily verified on a blockchain, and the chain of ownership (provenance) can be shown and also verified. However, an NFT is separate from the asset that it represents and are valuable because each NFT stores information about a digital asset based on a real-world item. So, for recyclables, an attributably portion of recyclable material deposited at collection facility 16 may be converted into an NFT 46, thereby creating ownership in the attributably portion of recyclable material in the customer. Ownership entitles a customer or municipality 47 to sell the NFT on an open market 49, such as an NFT auction market like OpenSea or similar website.

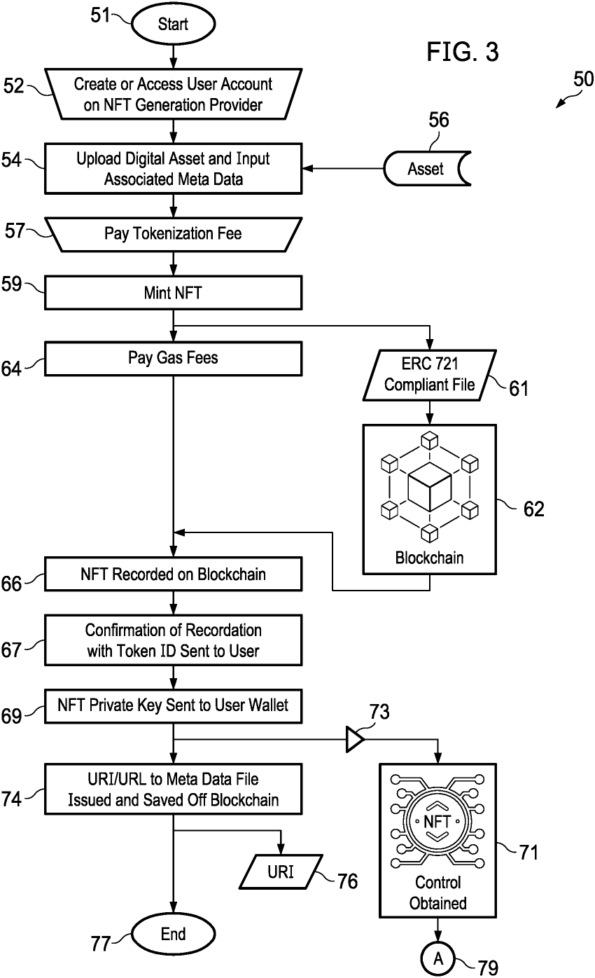

Referring to FIG. 3, it may now be seen how a tokenization process 50 occurs for a customer attributable amount of recyclable material. For the purposes of this disclosure, the term “tokenization” is defined as the process of converting rights to an asset into a digital token on a blockchain. Critically, tokenization must move legal rights in a real-world asset onto a decentralized blockchain. This is accomplished through a smart contract that allows for an asset to enjoy the market fluidity of a cryptocurrency, such as for example Bitcoin, while keeping the characteristics of the asset. For the present disclosure, the asset being tokenized is a numerically specified, attributable amount, either by volume or weight, of recyclable materials assigned to customer within a collection jurisdiction.

The creation of a digital asset can be done by drafting a software compliant file and submitting that file for execution on a selected blockchain. For example, a software file may be submitted to the Ethereum network as long as the file functions in a manner that is compliant with a particular file standard accepted on the Ethereum network. For example, the ERC721 file standard is one such standard, but any decentralized blockchain that allows for the use of smart contracts and the creation of NFT’s will allow the creation of an NFT representing the recyclable material. ERC-721 was the first standard for representing nonfungible digital assets on the Ethereum blockchain. Importantly, ERC-721 includes “inheritable” through the Solidity smart contract protocol, meaning that developers can easily create new ERC-721 compliant contracts by importing them from an open library. ERC-721 provides core methods that allow tracking the owner of a unique identifier, as well as an easy technical path for the owner to transfer an asset to a third party.

Another superior feature of the Ethereum network is that the ERC1155 standard permits a perception for digital asset owners “semi-fungibility.” The ERC1155 standard is a superset of ERC721 standard meaning that an ERC721 asset can be created using the ERC1155 standard. Unlike ERC721 where a unique ID represents a single asset, the unique ID of an ERC 1155 token represent a class of assets, and the metadata includes an additional quantity field to represent a numerical quantity that the class to which an asset pertains allows. Any assets under the same class is interchangeable, and the user can transfer any amount of those assets to a third party. Hence, multiple copies of seemingly similar or even identical assets can be recorded on a targeted blockchain, like the Ethereum blockchain. This is one reason why the Ethereum network has risen to become the most popular platform for NFT’s.

However, the drafting of such a compliant computer file requires substantial programming skills and understanding on how smart contracts operate and tokens are submitted for processing on a blockchain. Most users, whether individual users or municipal users hire a third-party service provider to generate an NFT. Such providers usually make their services available through a non-technical, user-friendly graphical interface accessible over the internet using a personal computing device, or other similar computing device like as a notebook computer, smartphone, or Personal Computer (“PC”). Once certain information is inputted to the third-party service website, the requisite computer files can be generated by the third-party service in accordance with the provider’s internal coding templates and in compliance with a targeted blockchain (e.g. ERC721 for the Ethereum blockchain). Two such third-party service providers, popular currently, and accessible through the internet are OpenSea and Rarible. Other potential tokenization service providers are: SuperRare; Binance NFT Marketplace; Zora; Nifty Gateway; Foundation; Terra Virtua; Axie Marketplace; Async Art; NFT ShowRoom; and Makersplace.

Process 50 starts 51 by creating or accessing a user account on a nonfungible token generation provider 52, such as for example Rarible accessible at https://rarible.com/. An asset 56 is turned into a digital asset by uploading a digital representation of the asset 54and inputting data associated with the asset, usually referred to as “metadata.” The most common metadata required for nonfungible token generation is the title of the asset, the creator, the creation date, the owner (creator and owner may be the same), the price, and a description of the asset. In some instances, a digital image may also be included. The price is set by the creator of asset, typically based on what they believe the asset would be worth on the open market. For example, a solid waste collection contractor may do extensive research on the value of recyclables in an applicable market, and then include value additions based on merchantability of recyclables once tokenization is complete for a particular volume or weight of recyclables. Hence, the waste collection contractor would be the creator of the recyclable material, the date would be the date on which the collection ticket was generated, and the owner would be the waste collection contractor. A scanned image of a ticket or a fictionalized ticket image created by the waste collection contractor could also be included. The waste collection contractor retains this information in its own centralized database for use later in the tokenization process.

The user, the waste collection contractor, must then pay a tokenization fee 57, which is essentially the combination of a service fee collected by the third-party tokenization provider and a transaction fee for processing of the digital asset by a “validator” sometimes referred to as a “miner” or a “staker,” depending upon the blockchain ethos (i.e. the guiding software rules and standards adhered to by users of the targeted blockchain platform) upon which the digital asset is to be recorded. A validator is a third party unrelated to the tokenization service provider to whom the token provider transfers the minted token for recordation on the targeted blockchain. As is understood, Validators fulfill a process of creating individual blocks added to the blockchain by solving complex mathematical problems. The purpose of validating is to verify cryptocurrency transactions and show something called “proof of work,” by adding the digital asset information to a block on the blockchain. As is known in the cryptocurrency industry, a blockchain acts as a ledger for mining transactions, thereby recording in a public manner every transaction occurring on the blockchain. In order for recordation of an NFT to be recorded on a targeted blockchain, a validator must be paid fees, usually referred to as “gas fees” as will be further discussed.

In order to pay the tokenization fee, a user must have a cryptocurrency compatible “digital wallet” from which funds may be provided to the tokenization service provider. A digital wallet is a software-based system that securely stores a user’s payment information and passwords for numerous payment methods and service providers. Digital wallets are essentially financial accounts that allow users to store funds, make transactions, and track payment histories with various types of computing devices (e.g. a smart phone, PC, or tablet). An owner of a digital wallet may send and receive cryptocurrency electronically. For example, a user may email a wallet address to a third party and that third party may send funds to that wallet address in seconds. Digital cryptocurrency wallets are different from digital fiat currency wallets held by, for example, Paypal (Venmo), Google Pay, or Zella, because these types of wallet use a centralized database to keep track of a user’s ledger and usually only allow payments in a common fiat currency in which a user resides. Examples of popular Digital cryptocurrency wallet providers are: Metamask; Kraken; eToro; Coinbase; Exodus; Coinomi; Trezor; and Sugi (hardware wallet).

Almost all digital wallets are optimized to hold cryptocurrencies such as Bitcoin, and to allow for electronic payment of anything that will accept a cryptocurrency for payment. A tokenization service provider requires payment in a cryptocurrency specific to the blockchain and ethos within which the blockchain exists. For example, if a service provider targets the Ethereum blockchain, the user’s digital wallet will hold and provide for the transfer of the cryptocurrency “Ether” (currency symbol, “ETH”).

Digital wallets vary in their function and independence. For example, a digital wallet may be held by the service provider as part of its service and act as a custodian of the digital wallet for the user, or the user may use a digital wallet as part of a decentralized application, often called a “DApp,” to hold their cryptocurrency.

Using the above referenced Rarible example, a user loads sufficient funds into their wallet for use in the tokenization effort and connects that wallet to Rarible or, alternatively, if Rarible is the wallet custodian authorizes access to the wallet funds on the user’s account. The fees may then be deducted from the digital wallet and internally applied to the users account on Rarible. The exact process for authorizing a funds transfer, the type of cryptocurrency utilized, and the authorization screens presented to the user vary with each service provider, but the purpose is the same. Further discussion regarding the use and formation of a digital wallet shall be omitted since they are well understood applications in the industry and not necessary for a complete understanding of the invention.

Once the fees are paid to the tokenization service provider 57, the tokenization service provider creates or “mints” the nonfungible token 59. Using the Ethereum platform example, the service provider creates a digital file holding the meta information inputted by the user, fees available for consumption by a validator (e.g. a Miner), and software code enabling the file to be processed on the Ethereum blockchain. Currently, the standard to which a digital file must comply on the Ethereum network is ERC721 (61) or ERC1155. However, the Ethereum network allows for evolving standards to allow for cross network (blockchain platform) validating and the inventors anticipate that other standards shall be published to which the Ethereum and other nonfungible token blockchain ethos will adopt. Hence, file 61 would need to comply with whatever is the most recent acceptable standard for a targeted blockchain 62.

During the minting process 59, gas fees are paid 64 to validators (e.g. miners). As part of the tokenization fee payment process 57, gas fees are anticipatorily suggested to the user based on the type, value, and size of the digital asset 56. The user has the ability to increase or decrease the amount of gas to be paid during step 59. The more gas that is made available for validating, the faster the digital asset will be incorporated into the blockchain. Validators will as is known compete for access to gas fees and based on current processing demands on the Ethereum network will accept payment for processing an ERC721 compliant file, thereby adding the digital asset on the Ethereum blockchain 66. As is further known, the amount and consumption of gas fees to process a transaction varies not only with the digital asset being processed, but also varies with the particular system currently implemented by the cryptocurrency network on which the targeted blockchain operates. For example, Ethereum Improvement Proposal 1559 (EIP 1559) was recently implemented on the Ethereum network which altered how fees are estimated. The inventors anticipate that the manner in which gas fees are calculated, the manner in which validating priority is established with gas fees, and the final processing cost amount will vary with each cryptocurrency network and the then current EIP adopted for a particular platform.

It is notable that variations on the blockchain payment structure and validation, and the consensus between miners required for validation, is evolving. The validation process currently uses a “node” that runs (i.e. executes) on a device with extremely high processing power called a “mining rig” or a cryptocurrency mining application. The owner of the mining rig receives a rewards in cryptocurrency for each block added to the chain on which the mining rig is processing transactions. This reward is how miners make money and ensure the validity, integrity and security of the blockchain on which their rigs operate. Currently, the most popular method to validate or record a digital asset on a blockchain is through “proof of work” but other methods of validation exist such as proof of stake (PoS) or proof of authority (PoA). Proof of work or “PoS.” is a form of cryptographic zero-knowledge proof in which one party (the “prover”) proves to others (the validators) that a certain amount of a computational effort is expended in order to obtain “consensus” from the other validators. Cryptographic consensus is required for a group of transactions to be added to a blockchain. PoS uses validators who “lock up” their coins on the applicable blockchain who are then randomly selected at intervals to create a block. This amount of locked up cryptocurrency is referred to as a “stake” and provides inventive to validators to maintain network security. Usually, there is a minimum amount needed to participate in the staking of a blockchain, so stakers usually create a pool of cryptocurrency referred to as a “staking pool.”

The Proof of Stake (PoS) method is a concensus method that allows for an alternative to the Proof of Work (PoW) method which can be highly resource intensive. Staking serves the same function as mining, that is creating trust in the network, adding blocks to the chain, and validating transactions in a secure manner, but with lower computer hardware costs and electricity costs. The PoS method allows for faster block validation transactions, albeit with larger blockchain sizes. Examples of cryptocurrencies that utilize PoS validation methods are Cardano (ADA), Tezos (XTZ), and Algrand (ALGO). Cardano (ADA) is an example of a cryptocurrency that uses staking, while more established cryptocurrencies like Bitcoin rely on mining and the Proof of Work method. Other cryptocurrencies (including Ethereum) are currently transitioning from mining (PoW) to a staking (PoS) model. Therefore, the inventors anticipate that both PoW and PoS systems can be used to implement the herein disclosed invention for the purposes of validating a digital asset onto a blockchain.

While the process of validating the recordation of a nonfungible token on a blockchain is a vital step in the tokenization process, the full technical details of the validation processes, whether based on PoW or PoS, is well understood in the cryptocurrency industry and not necessary for a complete understanding of the herein described invention. Hence, further discussion regarding those validation details shall be omitted.

Once a consensus has been reached on a transaction, in other words when a digital asset has been successfully added to the blockchain 66, a confirmation of recordation and a Token identification number is sent to the user 67. A private key is then sent to the user’s wallet 69 which effectively transfers control 73 of the nonfungible token to the user which establishes ownership 71 in the user for the token. A URI (Unique Resource Identifier) 76 and/or a URL (Uniform Resource Locator) are issued to the user 74 to facilitate further trading in open commerce of the newly created nonfungible token. The generated URI is saved off the blockchain 62 (i.e. not recorded on the same blockchain) in the tokenization process 50. It is preferred that any metadata file or associated identifiers, including all URI’s be saved on as non-centralized file storage system, such as the Interplanetary File System (IPFS) or similar decentralized file system. This completes 77 the tokenization of the digital asset.

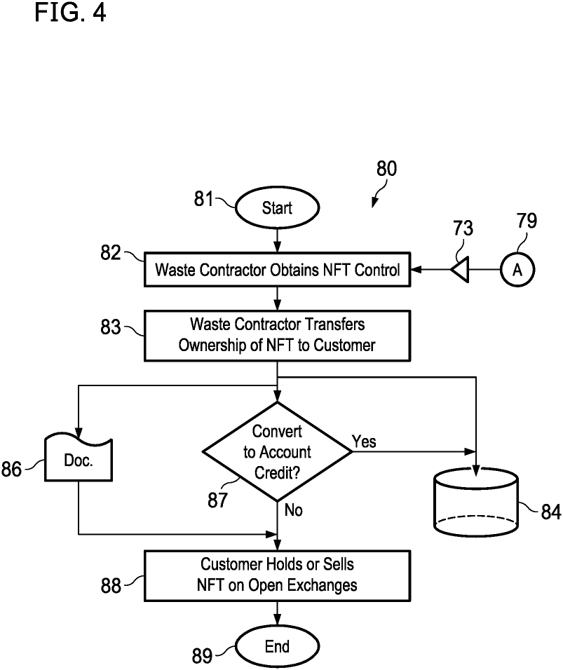

Referring to FIG. 4, as is understood, the user in the tokenization process for FIG. 3 is the waste contractor (15) that collected the recyclables (see FIG. 1). Once waste contractor 15 obtains control of the nonfungible token 82, the waste contractor 15 is able to transfer ownership of the nonfungible token to the waste contractor customer 83. The transfer is saved into the contractor-controlled database 84 and a document issued 86 to the customer confirming their ownership in the nonfungible token. Database 84 is a centralized databased controlled by the contractor 15 and keeps track (essentially a traditional ledger) of all instances of nonfungible tokens representing a plurality of instances of collections of recyclables. Any particular generated NFT represents the collected recyclables attributable to customer collected in the collection area during a particular municipal solid waste collection cycle.

Each collection instance including data such as the amount of recyclables collected and the assigned value of those recyclables is recorded in database 84. Generation of document 86 is important because the document effectuates the transfer of legal ownership of the nonfungible token in the customer. Document 86 may consist of a traditional legal contract in which the parties (customer and contractor) form a legally binding agreement assigning all rights in the nonfungible token to the customer, and potentially the waste contractor may transfer the nonfungible token to a digital wallet designated by the customer.

Preferably the contractor 15 offers to the customer to obtain credit to their collection account for the same fiat currency value of the NFT. This is accomplished by the contractor offering to convert the issued nonfungible tokens into currency value and then credit that determined value to the customer’s account 87 and recorded in centralized database 84. At any point after a first nonfungible token is assigned to a customer, the customer may accept this offer from the contractor 15. The actual mechanism of how the nonfungible token(s) are transferred back to the contract may vary in timing and implementation. For example, the customer may transfer the nonfungible token(s) back to the contractor via legal contract 86, and/or such a transfer may be supplemented/implemented by the sending of the token(s) to a digital wallet held by the contractor at a later time.

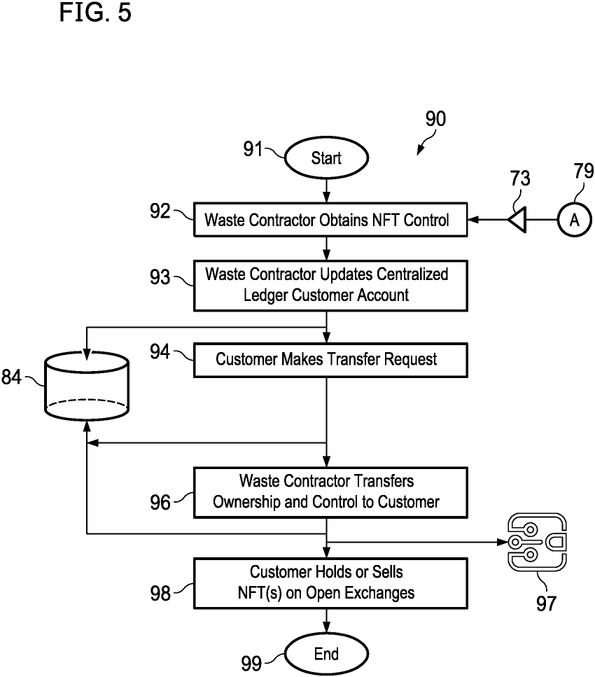

In another variation, retransfer of the token back to the customer may occur through the updating of a centralized ledger via notation only. In accordance with FIG. 5, contractor 15 may replace step 83 (FIG. 4) by simply updating a centralized ledge 93 in database 84 while not immediately implementing any type of actual ownership transfer. This is an alternative embodiment 90 to process 80 in FIG. 4, so that processing of such ownership transfer can be efficiently handled for a plurality of customers. As shown, after starting 91, the contractor waits until a customer desires to have full and complete legal rights in the token(s) at which time a customer may submit an ownership transfer request 94 to the contractor, preferably via email or other structured electronic request. The contractor then transfers the rights in the nonfungible token(s) to the customer 96, including if necessary electronically sending the token(s) to the customer’s digital wallet 97. The contractor database is also updated 84 at that time. The result is that the customer obtains full ownership rights and digital rights simultaneously from which they may hold or sell their nonfungible tokens on open exchanges 98, thereby completing process 99.

NFTs can be bought in several ways, including peer-to-peer but the most common is through an NFT marketplace such as Rarible indicated above. Hence, the tradeable nature of the recyclable NFT’s created in process 30 allows for customers to obtain wealth from their recovered recyclables with a minimum of effort. Over time, a collection of recyclable NFT’s may result in substantial wealth for a customer, the redemption of which may be recovered at a time of choosing by the customer. More importantly, interest in the recovery of and generation of interim recycled raw materials from recyclables should grow from such NFT generation. Hence, recyclable NFT generation can hopefully turn public sentiment toward recycling, including altering the currently unpopular sentiment of recycling into a sentiment of enablement, including the allocation of public funds in support of recycling equipment and recycling reclamation technology.

While I have shown my invention in one form, it will be obvious to those skilled in the art that it is not so limited but is susceptible of various changes and modifications without departing from the spirit thereof.

What is claimed is:

1. A process for establishing ownership and value in collected recyclables, comprising the steps of:
a. determining a fractional amount of recyclables occurring in a solid waste collection jurisdiction for each customer in said collection jurisdiction;
b. collecting solid waste in said collection jurisdiction during a collection cycle;
c. transporting said collected solid waste to a materials recovery facility;
d. determine the weight of said transported collected solid waste;
e. assigning a fractional amount of solid waste attributable to each customer serviced during said collection cycle;
f. based on said step of determining a fractional value of recyclables in a solid waste collection jurisdiction, calculating a fractional amount of recyclable material in said assigned fractional weight of collected solid waste for each customer serviced in said collection jurisdiction during said collection cycle;
g. recording said attributable fractional amount of recyclable material to each customer account for said collection cycle; and,
h. minting a nonfungible token representing said attributable fractional amount of recyclable material for each customer and recording said nonfungible token on a decentralized blockchain.

2. The process as recited in claim 1, wherein said step of assigning a fractional amount by solid waste attributable to each customer serviced during said collection cycle, comprises the steps of:
a. based on demographics of each area present in said collection jurisdiction during said collection cycle, assigning a pre-established solid waste collection expectation amount for each customer serviced during said collection cycle;
b. assigning a weighting factor for each customer serviced during said collection cycle based on said prior assigned solid waste collection expectation value in relation to all other pre-established solid waste collection expectation amount in said collection jurisdiction; and,
c. based on said pre-established solid waste collection expectation value and said assigned weighting factor, calculating said fractional amount of solid waste attributable to each customer serviced during said collection cycle in said collection jurisdiction.

3. The process as recited in claim 2, wherein said step of minting a nonfungible token, comprises the steps of:
a. accessing a user account on a nonfungible token generation provider;
b. creating a digital asset representing said attributable fractional amount of recyclable material collected for each customer in said collection jurisdiction;
c. inputting meta data associated with said digital asset;
d. uploading said created digital asset for each customer and paying a tokenization fee for said digital asset;
e. based upon said digital asset and said inputted meta data, minting a nonfungible token; and,
f. recording said minted token on a decentralized blockchain.

4. The process as recited in claim 3, further including the steps of:
a. responsive to said recordation of said minted token on a decentralized blockchain, recording a token identification number in a database; and
b. associating said token identification number with said customer in said database.

5. The process as recited in claim 4, wherein said step of recording said minted nonfungible token on a decentralized blockchain includes the step of paying gas fees.

6. The process as recited in claim 5, further including the step of converting the value of said nonfungible token into fiat currency and crediting said fiat currency amount to a customer account held by a waste contractor servicing said collection jurisdiction.

7. The process as recited in claim 4, further including the step of transferring ownership of said nonfungible token to said customer.

8. The process as recited in claim 1, wherein said step of minting a nonfungible token, comprises the steps of:
a. accessing a user account on a nonfungible token generation provider;
b. creating a digital asset representing said attributable fractional amount of recyclable material collected for each customer in said collection jurisdiction;
c. inputting meta data associated with said digital asset;
d. uploading said created digital asset for each customer and paying a tokenization fee for said digital asset;
e. based upon said digital asset and said inputted meta data, minting a nonfungible token; and,
f. recording said minted token on a decentralized blockchain.

9. The process as recited in claim 8, wherein said step of assigning a fractional amount of solid waste attributable to each customer comprises the steps of:
a. transmitting a human discernable image of an issued weight ticket displaying the weight of said collected solid waste during said collection cycle to a worker;
b. based on said predetermined fractional amount of recyclables, said worker calculating a fractional amount of recyclables attributable to each customer serviced during said collection cycle; and,
c. recording said attributable amount of recyclables for each customer in a database.

10. The process as recited in claim 9, further including the step of transferring ownership of said nonfungible token to said customer.

11. The process as recited in claim 8, further including the step of transferring a private key associated with said nonfungible token to a digital wallet designated by a waste contractor servicing said collection jurisdiction thereby transferring ownership of said minted nonfungible token to said waste contractor.

12. The process as recited in claim 11, further including the step of sending a metadate unique resource identifier to each customer and recording said metadata in a decentralized file system.

13. The process as recited in claim 8, wherein said step of minting a nonfungible token comprises minting an ERC721 smart contract compliant token.

14. The process as recited in claim 1, wherein said step of assigning a fractional amount of solid waste attributable to each customer comprises the steps of:
a. transmitting a human discernable image of an issued weight ticket displaying the weight of said collected solid waste during said collection cycle to a worker;
b. based on said predetermined fractional amount of recyclables, said worker calculating a fractional amount of recyclables attributable to each customer serviced during said collection cycle; and,
c. recording said attributable amount of recyclables for each customer in a database.

15. The process as recited in claim 1, further including the step of converting the value of said nonfungible token into fiat currency and crediting said fiat currency amount to a customer account held by a waste contractor servicing said collection jurisdiction.

16. A process for establishing ownership and value in collected recyclables, comprising the steps of:
a. Establishing a fractional expectation value of recyclables present in a collected amount of solid waste for each customer in said collection jurisdiction;
b. Using a collection vehicle, collecting solid waste in said collection jurisdiction during a collection cycle until said collection vehicle is full;
c. at a materials sorting facility, determine the weight of said collected solid waste in said collection vehicle;
d. assigning a fractional amount of solid waste attributable to each customer serviced by said collection vehicle in said collection jurisdiction;
e. using said fractional expectation value, determining a fractional amount of recyclable material for each customer serviced in said collection jurisdiction;
f. recording said attributable fractional amount of recyclable material to each customer account for said collection cycle; and,
g. minting a nonfungible token representing said attributable fractional amount of recyclable material for each customer and recording said nonfungible token on a decentralized blockchain.

17. The process as recited in claim 2, wherein said step of minting a nonfungible token, comprises the steps of:
a. accessing a user account on a nonfungible token generation provider;
b. creating a digital asset representing said attributable fractional amount of recyclable material collected for each customer in said collection jurisdiction;
c. inputting meta data associated with said digital asset;
d. uploading said created digital asset for each customer and paying a tokenization fee for said digital asset;
e. based upon said digital asset and said inputted meta data, minting a nonfungible token; and,
f. recording said minted token on a decentralized blockchain.

18. The process as recited in claim 17, further including the step of transferring a private key associated with said nonfungible token to a digital wallet designated by a waste contractor servicing said collection jurisdiction thereby transferring ownership of said minted nonfungible token to said waste contractor.

19. The process as recited in claim 18, further including the step of upon request of said customer said waste contractor transferring ownership of said nonfungible token to said customer.

20. A process for establishing ownership and value in collected recyclables, comprising the steps of:
a. establishing a fractional expectation value of recyclables present in a collected amount of solid waste for each customer in said collection jurisdiction;
b. Using a collection vehicle, collecting solid waste in said collection jurisdiction during a collection cycle until said collection vehicle is full;
c. determine the weight of said collected solid waste in said collection vehicle by comparing the weight of said collection vehicle between being full of said collected solid waste and after emptying said collected solid waste;
d. assigning a fractional amount of solid waste attributable to each customer serviced by said collection vehicle in said collection jurisdiction;
e. using said fractional expectation value, determining a fractional amount of recyclable material attributable to each customer serviced in said collection jurisdiction;
f. recording said attributable amount of recyclable material for each customer serviced by said collection vehicle during said collection cycle; and,
g. through a third-party tokenization service provider, minting a nonfungible token having metadata establishing a predetermined value of said attributable fractional amount of recyclable material for each customer and using a smart contract recording said nonfungible token on a decentralized blockchain so that said nonfungible token represents said value of said attributable fractional amount of recyclable material.
